(19) United States
(12) Patent Application Publication
(10) Pub. No.: US 2010/0151241 A1
(43) Pub. Date: Jun. 17, 2010

(54) 2-Octyl (Meth)acrylate Adhesive Composition

(75) Inventors: Cordell M. Hardy, Roseville, MN (US); John W. Frank, Cottage Grove, MN (US); Chi-Ming Tseng, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/337,185

(22) Filed: Dec. 17, 2008

(51) Int. Cl. B32B 27/06; C08F 220/10; B32B 27/08

(52) U.S. Cl. 428/355 AC; 526/318.4; 526/318.44

(57) ABSTRACT

A pressure sensitive adhesive composition comprising a 2-octyl(meth)acrylate, (meth)acrylic acid copolymer and optional crosslinking agents is described. The adhesive composition may be derived from renewable resources and provides good peel, shear and high temperature stability.

This application claims the benefit of Provisional Application No. 61/044,748, filed Apr. 14, 2008.

### BACKGROUND

Pressure sensitive adhesives (PSAs) are known to possess properties including the following: (1) aggressive and permanent tack, (2) adherence with no more than finger pressure, (3) sufficient ability to hold onto an adherend or substrate, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not embrace compositions merely because they are sticky or adhere to a surface.

Only a limited number of classes of polymers have been found to function as PSAs. Among these polymer classes are natural and synthetic rubbers, (meth)acrylic polymers, silicones, block copolymers and olefins. Acrylic polymers have proven especially useful. Acrylic based PSAs are frequently prepared from isooctyl acrylate or 2-ethylhexyl acrylate. These adhesives have many desirable attributes such as high peel adhesion when applied to a wide variety of surfaces.

Further, acryclic PSAs are generally derived from petroleum feedstocks. The increase in the price of oil, and concomitant petroleum-derived products, has led to volatile prices and supply for many adhesive products. It is desirable to replace all or part of the petroleum-based feedstocks with those derived from renewable sources, such as plants, as such materials become relatively cheaper, and are therefore both economically and socially beneficial. Therefore, the need for such plant-derived materials has become increasingly significant.

### SUMMARY

The present invention provides an adhesive composition derived from renewable resources. In particular, the present invention provides an adhesive composition derived, in part, from plant materials. Such materials typically have a higher Carbon-14 isotope composition than petroleum-based feedstocks. In some embodiments, the present invention further provides an adhesive article, wherein the substrate or backing is also derived from renewable resources. The pressure sensitive adhesive composition comprises a 2-octyl(meth)acrylate/(meth)acrylic acid copolymer and optionally a crosslinking agent. As used herein (meth)acrylate or (meth)acrylic is inclusive of methacrylate and acrylate. The adhesive composition may be extruded, coated, or sprayed directly onto a substrate or surface that is to be bonded to another substrate or surface.

The invention also provides adhesive articles such as tapes and the like comprising a layer of the foregoing pressure sensitive (meth)acrylic adhesive disposed on a support or backing. The support may be a release substrate or liner to provide a so-called transfer tape wherein the exposed adhesive may be placed in contact with a substrate or surface and the release liner may thereafter be stripped away from the adhesive to expose another portion of the adhesive for bonding to another substrate or surface. The adhesive article may be provided as a tape or an adhesive sheet which can be prepared by any of a variety of known methods such as by extruding, coating, or spraying the adhesive composition onto a backing layer. The pressure sensitive (meth)acrylic adhesive tape or sheet can be laminated onto a surface or substrate. The tape or sheet can also be die-cut into any desired shape.

The present adhesive composition, derived from 2-octyl(meth)acrylate, provides comparable adhesive properties when compared with other isomers of octyl(meth)acrylate, such as n-octyl and isooctyl.

### DETAILED DESCRIPTION

The adhesive composition comprises

a) a copolymer comprising:
1) 30 to less than 90 wt. % of 2-octyl(meth)acrylate, preferably 60 to less than 90 wt. %;
2) 0.5 to 20 wt. % of a carboxylic acid functional comonomer, preferably (meth)acrylic acid;
3) Other monomers, and

b) optional crosslinking agent(s).

The 2-octyl(meth)acrylate may be prepared by conventional techniques from 2-octanol and (meth)acryloyl derivatives such as esters, acids, and acyl halides. The 2-octanol may be prepared by treatment of ricinoleic acid, derived from castor oil, (or ester or acyl halide thereof) with sodium hydroxide, followed by distillation from the co-product sebacic acid.

Examples of other monomers that may be co-polymerized with the (meth)acrylate ester and carboxylic acid-functional monomers include C₁-C₁₀ (meth)acrylates such as methyl(meth)acrylate, cyclohexyl(meth)acrylate, butyl(meth)acrylates, phenyl(meth)acrylate,_primary octyl acrylates such as 2-ethylhexyl acrylate and 6-methylheptyl(meth)acrylate; further examples include N-vinyl pyrrolidone, (meth)acrylamides, alpha-olefins, vinyl ethers, allyl ethers, styrene and other aromatic vinyl compounds, maleic acid esters, 2-hydroxyethyl(meth)acrylate, N-vinyl caprolactam, and substituted (meth)acrylamides such as N-ethyl(meth)acrylamide, N-hydroxyethyl(meth)acrylamide, N-octyl(meth)acrylamide, N-t-butyl(meth)acrylamide, N,N-dimethyl(meth)acrylamide, N,N-diethyl(meth)acrylamide, and N-ethyl-N-dihydroxyethyl(meth)acrylamide.

The copolymerizable mixture may optionally further comprise chain transfer agents to control the molecular weight of the resultant polymer. Examples of useful chain transfer agents include but are not limited to those selected from the group consisting of carbon tetrabromide, alcohols, mercaptans, and mixtures thereof. When present, the preferred chain transfer agents are isooctylthioglycolate and carbon tetrabromide. The polymerization mixture may further comprise up to about 0.5 parts by weight (pbw) of a chain transfer agent, typically about 0.01 to about 0.5 pbw, preferably about 0.05 to about 0.2 pbw, based upon 100 pbw of the total monomer mixture.

In the practice of the invention, the copolymers can be polymerized by techniques including, but not limited to, the conventional techniques of solvent polymerization, emulsion polymerization, solventless bulk polymerization, and radiation polymerization, including processes using ultraviolet light, electron beam, and gamma radiation. The monomer mixture may comprise a polymerization initiator, especially a thermal initiator or a photoinitiator of a type and in an amount effective to polymerize the comonomers.

Initiators useful in preparing the (meth)acrylate adhesive polymers used in the present invention are initiators that, on exposure to heat or light, generate free-radicals which initiate (co)polymerization of the monomer mixture. These initiators can be employed in concentrations ranging from about 0.0001 to about 3.0 pbw, preferably from about 0.001 to about 1.0 pbw, and more preferably from-about 0.005 to about 0.5 pbw, per 100 pbw of the monomer composition.

A typical emulsion polymerization method is carried out by agitating water, monomer, surfactant, initiator, and optionally other additives in the presence of heat (typical temperatures are 50-95° C.). The monomer is understood to migrate into surfactant micelles where it polymerizes into polymer particles.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

Suitable initiators include but are not limited to those selected from the group consisting of azo compounds such as VAZO 64 (2,2′-azobis(isobutyronitrile)), VAZO 52 (2,2′-azobis(2,4-dimethylpentanenitrile)), and VAZO 67 (2,2′-azobis-(2-methylbutyronitrile)) available from E.I. du Pont de Nemours Co., peroxides such as benzoyl peroxide and lauroyl peroxide, and mixtures thereof. The preferred oil-soluble thermal initiator is (2,2′-azobis-(2-methylbutyronitrile)). When used, initiators may comprise from about 0.05 to about 1 part by weight, preferably about 0. 1 to about 0.5 part by weight based on 100 pbw of monomer components in the pressure sensitive adhesive.

In a typical photopolymerization method, a monomer mixture may be irradiated with ultraviolet (UV) rays in the presence of a photopolymerization initiator (i.e., photoinitiators). Preferred photoinitiators are those available under the trade designations IRGACURE and DAROCUR from Ciba Specialty Chemical Corp., Tarrytown, N.Y. and include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173). Particularly preferred photoinitiators are IRGACURE 819, 184 and 2959.

Solventless polymerization methods, such as the continuous free radical polymerization method described in U.S. Pat. Nos. 4,619,979 and 4,843,134; the essentially adiabatic polymerization methods using a batch reactor described in U.S. Pat. No. 5,637,646; and, the methods described for polymerizing packaged pre-adhesive compositions described in U.S. Pat. No. 5,804,610 may also be utilized to prepare the polymers.

The packaging material is made of a material that when combined with the base copolymer or plasticized pressure sensitive adhesive composition does not substantially adversely affect the desired pressure sensitive adhesive characteristics. A hot melt coated pressure sensitive adhesive produced from a mixture of the pressure sensitive adhesive and the packaging material may have improved pressure sensitive adhesive properties compared to hot melt coated pressure sensitive adhesive produced from pressure sensitive adhesive alone.

The packaging material should be appropriate for the polymerization method used. For example, with photopolymerization, it is necessary to use a film material that is sufficiently transparent to ultraviolet radiation at the wavelengths necessary to effect polymerization. Polymerization can be effected by exposure to ultraviolet (UV) radiation as described in U.S. Pat. No. 4,181,752. In a preferred embodiment, the polymerization is carried out with UV black lights having over 60 percent, and preferably over 75 percent of their emission spectra between 280 to 400 nanometers (nm), with an intensity between about 0.1 to about 25 mW/cm².

In another preferred solventless polymerization method, the pressure sensitive adhesives of the present invention are prepared by photoinitiated polymerization methods according to the technique described in U.S. Pat. No. 4,181,752, hereby incorporated by reference. The comonomers, and a photoinitiator are mixed together in the absence of solvent and partially polymerized to a viscosity in the range of from about 500 cps to about 50,000 cps to achieve a coatable syrup. Alternatively, the monomers and photoinitiator are mixed in the absence of solvent and partially polymerized to make a syrup. The plasticizing agent is then added to the syrup to make a coatable mixture for further polymerization. In yet another way, the monomers, and plasticizing agent may be mixed with a thixotropic agent such as fumed hydrophilic silica to achieve a coatable thickness. The crosslinking agent and any other ingredients are then added to the prepolymerized syrup or thickened plasticized monomer mixture. Alternatively, these ingredients (with the exception of the crosslinking agent) can be added directly to the monomer mixture prior to pre-polymerization.

The resulting composition is coated onto a substrate (which may be transparent to ultraviolet radiation) and polymerized in an inert (i.e., oxygen free) atmosphere, e.g., a nitrogen atmosphere by exposure to ultraviolet radiation. Examples of suitable substrates include release liners (e.g., silicone release liners) and tape backings (which may be primed or unprimed paper or plastic). A sufficiently inert atmosphere can also be achieved by covering a layer of the polymerizable coating with a plastic film which is substantially transparent to ultraviolet radiation, and irradiating through that film in air as described in the aforementioned patent using ultraviolet lamps. Alternatively, instead of covering the polymerizable coating, an oxidizable tin compound may be added to the polymerizable syrup to increase the tolerance of the syrup to oxygen as described in U.S. Pat. No. 4,303,485. The ultraviolet light source preferably has 90% of the emissions between 280 and 400 nm (more preferably between 300 and 400 nm), with a maximum at 351 nm.

The first component polymer may be prepared (e.g., by solution polymerization followed by isolation). Any residual monomer and/or solvents used in the preparation may be removed by conventional techniques such as distillation, vacuum evaporation, etc., to reduce the residual content to less than 2 wt. %, prior to crosslinking. The polymerizations may be conducted in the presence of suitable solvents such as ethyl acetate, toluene and tetrahydrofuran that are unreactive with the acid or ester functional groups of the monomers.

In order to increase cohesive strength of the poly(meth)acrylate pressure sensitive adhesives, an optional crosslinking agent may be incorporated into the adhesive composition. Two main types of chemical crosslinking agents are exemplary. The first crosslinking additive is a thermal crosslinking agent such as multifunctional aziridine, isocyanate, oxazole and epoxy compounds. One example of aziridine crosslinker is 1,1′-(1,3-phenylene dicarbonyl)-bis-(2-methylaziridine) (CAS No. 7652-64-4). Other bisamide crosslinking agents are described in U.S. Pat. No. 6,893,718 (Melancon et al.), incorporated herein by reference. Common polyfunctional isocyanate crosslinkers are trimethylolpropane toluene diisocyanate, toluene diisocyanate, and others known in the art. Such chemical crosslinkers can be added into solvent-based PSAs after polymerization and activated by heat during oven drying of the coated adhesive.

Bisamide crosslinking agents may be of the formula

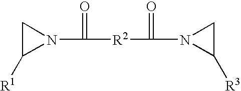

where,

R¹ and R³ are independently selected from the group consisting of H and CₙH₂ₙ₊₁, where n is an integer ranging from 1 to 5,

R² is a divalent radical selected from the group consisting of phenyl, substituted phenyl, triazine, and —CₘH₂ₘ—, where m is an integer ranging from 1 to 10, and combinations thereof

Multifunctional oxazoline crosslinking agents useful in this invention are those that contain two or more groups per molecule selected from the group consisting of 2-oxazolines, 2 oxazines and combinations thereof. Preferred 1,3-oxazyl heterocyclic compounds are 1,3-oxazolines, and a particularly preferred 1,3-oxazoline is 2-phenyl-2-oxazoline. Bisoxazolines are typically derived from polycarboxylic acids and such polycarboxylic acids include, but are not limited to aromatic acids; for example, isophthalic acid, terephthalic acid, 5-t-butylisophthalic acid, trimesic acid, 1,2,4,5-benezenetetracarboxylic acid and 2,6-naphthalene dicarboxylic acid. The preferred polycarboxylic acids include isophthalic acid, terephthalic acid and trimesic acid.

Polyfunctional 1,3-oxazyl heterocyclic compounds useful in this invention can be conveniently prepared by the reaction of the corresponding esters of a polycarboxylic acids and alkanolamines. Nonlimiting examples of poly(1,3-oxazyl heterocyclic) compounds including bisoxazolines are those having a nucleus represented by the following Formula I:

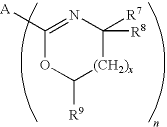

wherein A is selected from the group consisting of a cyclic or acyclic aliphatic or substituted cyclic or acyclic aliphatic moiety having from 1 to 20 carbon atoms or an aromatic (aryl) mono- or multinuclear or aliphatic substituted aryl residue having from 6 to 20 carbon atoms and a polymeric or oligomeric residue comprising from about 2 to 200,000 repeating units;

R⁷ independently represents H, CH₃, CH₂CH₃, or C₆H₅;

R⁸ and R⁹ independently represent H or CH₃, preferably R⁷ and R⁹ are not both CH₃;

x represents an integer of 0 or 1.

n is an integer of 2 or more, preferably 2 or 3.

Useful multifunctional oxazoline crosslinking agents include but is not limited to 4,4′-5,5′-tetrahydro-2,2′-bisoxazole, (that is, 2,2′-bis(2-oxazoline)); 2,2′-(alkanediyl)bis[4,5-dihydrooxazole], for example, 2,2′-(1,4-butanediyl)bis[4,5-dihydrooxazole] and 2,2′-(1,2-ethanediyl)bis[4,5-dihydrooxazole]; 2,2′-(arylene)bis[4,5-dihydrooxazole], e.g., 2,2′-(1,4-phenylene)bis[4,5-dihydrooxazole]; 2,2′-(1,5-naphthalenyl)bis[4,5dihydrooxazole] and 2,2′-(1,8-anthracenyl)bis[4,5-dihydrooxazole]; sulfonyl, oxy, thio or alkylene bis 2-(arylene)[4,5-dihydrooxazole], for example, sulfonyl bis 2-(1,4-phenylene)bis[4,5-dihydrooxazole], oxybis 2-(1,4-phenylene)bis[4,5-dihydrooxazole], thiobis 2-(1,4-phenylene)bis[4,5-dihydrooxazole] and methylene bis 2-(1,4-phenylene)bis[4,5-dihydrooxazole]; 2,2′,2″-(arylene tris [4,5-dihydrooxazole], e.g., 2,2′,2″-(1,3,5-phenylene tris[4,5-dihydrooxazole]; 2,2′,2″,2′″-(arylene tetra[4,5-dihydrooxazole], for example, 2,2′,2″,2′″-(1,2,4,5-phenylene tetra[4,5-dihydrooxazole] and oligomeric and polymeric materials having terminal oxazoline groups.

Typically, the relative amounts of (meth)acrylic acid co-monomer and crosslinking agent is selected so that the ratio of the number of equivalents of crosslinker functional groups (such as amide, oxazole, isocyanate or epoxy functional groups) to the number of equivalents of carboxylic acid groups is less than or equal to about 0.1. More typically, the ratio of the number of equivalents of amide groups to the number of equivalents of carboxylic acid groups is less than about 0.05, and generally will be between 0.0001 and 0.05. Most typically, the ratio of the number of equivalents of crosslinker functional groups to the number of equivalents of carboxylic acid groups will be between 0.0001 and 0.05.

In another embodiment, chemical crosslinkers, which rely upon free radicals to carry out the crosslinking reaction, may be employed. Reagents such as, for example, peroxides serve as a source of free radicals. When heated sufficiently, these precursors will generate free radicals which bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents. The second type of crosslinking additive is a photosensitive crosslinker, which is activated by high intensity ultraviolet (UV) light. Two common photosensitive crosslinkers used for (meth)acrylic PSAs are benzophenone and copolymerizable aromatic ketone monomers as described in U.S. Pat. No. 4,737,559 (Kellen et al.). Another photocrosslinker, which can be post-added to the solution polymer and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight.

Useful polyisocyanates include aliphatic, alicyclic, and aromatic diisocyanates, and mixtures thereof. A number of such diisocyanates are commercially available. Representative examples of suitable diisocyanates include hexamethylene diisocyanate (HDT), trimethyl hexamethylene diisocyanate (TMHDI), m- and p-tetramethylxylene diisocyanate (TMXDI), diphenylmethane diisocyanate (MDT), napthalene diisocyanate (NDI), phenylene diisocyanate, isophorone diisocyanate (IPDI), toluene diisocyanate (TDI), bis(4-isocyanatocyclohexyl)methane (H₁₂MDI), and the like, and mixtures thereof. Useful polyisocyanates also include derivatives of the above-listed monomeric polyisocyanates. These derivatives include, but are not limited to, polyisocyanates containing biuret groups, such as the biuret adduct of hexamethylene diisocyanate (HDI) available from Bayer Corp., Pittsburgh, Pa. under the trade designation DESMODUR N-100, polyisocyanates containing isocyanurate groups, such as that available from Bayer Corp., Pittsburgh, Pa. under the trade designation DESMODUR N-3300, as well as polyisocyanates containing urethane groups, uretdione groups, carbodiimide groups, allophonate groups, and the like. If desired, small amounts of one or more polyisocyanates having three or more isocyanate groups can be added to effect a degree of crosslinking. Preferred polyisocyanates include aliphatic diisocyanates and derivatives thereof, with IPDI being most preferred.

Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

Other additives can be included in the polymerizable mixture or added at the time of compounding or coating to change the properties of the pressure sensitive adhesive. Such additives, include pigments, tackifiers, fillers such as glass or polymeric bubbles or beads (which may be expanded or unexpanded), hydrophobic or hydrophilic silica, calcium carbonate, glass or synthetic fibers, blowing agents, toughening agents, reinforcing agents, fire retardants, antioxidants, and stabilizers. The additives are added in amounts sufficient to obtain the desired end properties.

If other additives are used, then up to about 40% by weight, preferably less than 30% by weight, and more preferably less than 5% by weight based on the dry weight of the total adhesive polymer, would be suitable.

A wide variety of resinous (or synthetic) materials commonly used in the art to impart or enhance tack of pressure sensitive adhesive compositions may be used as a tackifier (i.e., tackifying resin). Examples include rosin, rosin esters of glycerol or pentaerythritol, hydrogenated rosins, polyterpene resins such as polymerized beta-pinene, coumaroneindene resins, “C5” and “C9” polymerized petroleum fractions, and the like.

The use of such tack modifiers is common in the art, as is described in the Handbook of Pressure Sensitive Adhesive Technology, Second Edition, D. Satas, ed., Van Nostrand Reinhold, New York, N.Y., 1989. A tackifying resin is added in amounts required to achieve the desired tack level. Examples of suitable commercially available tackifiers include synthetic ester resins, such as that available under the trade designation FORAL 85 from Hercules Inc., Wilmington, Del., and aliphatic/aromatic hydrocarbon resins, such as those available under the trade designation ESCOREZ 2000 from Exxon Chemical Co., Houston, Tex. This is typically achieved by adding from 1 part to about 300 pbw of tackifying resin per 100 pbw of an acrylate copolymer. The tackifying resin is selected to provide the acrylate copolymers with an adequate degree of tack to maintain the resultant composition balanced pressure sensitive adhesive properties including shear and peel adhesion. As is known in the art, not all tackifier resins interact with the acrylate copolymer in the same manner; therefore, some minor amount of experimentation may be required to select the appropriate tackifier resin and to achieve optimum adhesive performance. Such minor experimentation is well within the capability of one skilled in the adhesive art.

Plasticizing agents selected for use in the polymerizable compositions of the present invention possess a range of properties. Generally, the plasticizing agents can be liquid or solid, have a range of molecular weights and architectures, are compatible with the base copolymers, monomeric or polymeric, non-volatile and non-reactive. Additionally, mixtures of solid and liquid, monomeric and polymeric and other combinations of plasticizing agents can be used in the present invention.

Generally, liquid plasticizing agents are readily compoundable with the base copolymers and/or can be chosen to be miscible with comonomers for plasticized pressure sensitive adhesive compositions prepared using bulk polymerization methods. In addition, liquid plasticizing agents may be delivered directly to non-tacky base copolymers or onto already coated base copolymer films and are typically absorbed quickly to activate the pressure sensitive adhesive properties.

Although somewhat more challenging to use, solid plasticizing agents can advantageously be used in applications, processes or articles where the controlled plasticization of the base copolymer is desired. For example, hot melt processible pressure sensitive adhesive compositions can be easily transported and handled prior to melt compounding if both the base copolymer and plasticizing agent components are solid and non-tacky. Once heated to the melting or glass transition temperature of the solid plasticizing agent, the base copolymer is plasticized and the mixture exhibits pressure sensitive adhesive properties.

Additionally, the plasticizing agents can have a range of molecular weights and architectures. That is, the plasticizing agents can be either polymeric or monomeric in nature. Typically, monomeric plasticizing agents are derived from low molecular weight acids or alcohols, which are then esterified with respectively a monofunctional alcohol or monofunctional acid. Examples of these are esters of mono- and multibasic acids, such as isopropyl myristate, dibutyl phthalate, diisoctyl phthalate, dibutyl adipate, dibutylsebacate and the like. Useful polymeric plasticizing agents are non-acrylic and are typically derived from cationically or free-radically polymerizable, condensation polymerizable or ring-opening polymerizable monomers to make low molecular weight polymers. Examples of these polymeric plasticizing agents include materials such as polyurethanes, polyureas, polyvinylethers, polyethers, polyesters and the like. As used in this application “non-acrylic” means the polymeric plasticizing agent contains less than about 20% by weight of any (meth)acrylic monomers.

Additionally, useful plasticizing agents are non-reactive, thus preventing copolymerization with the comonomers of the base copolymer. Thus, plasticizing agents having acrylate functionality, methacrylate functionality, styrene functionality, or other ethylenically unsaturated, free radically reactive functional groups are generally not used.

Particularly useful plasticizing agents include polyalkylene oxides having weight average molecular weights of about 150 to about 5,000, preferably of about 150 to about 1,500, such as polyethylene oxides, polypropylene oxides, polyethylene glycols; alkyl or aryl functionalized polyalkylene oxides, such as PYCAL 94 (a phenyl ether of polyethylene oxide, commercially available from ICI Chemicals); benzoyl functionalized polyethers, such as BENZOFLEX 400 (polypropylene glycol dibenzoate, commercially available from Velsicol Chemicals) and monomethyl ethers of polyethylene oxides; monomeric adipates such as dioctyl adipate, dibutoxyethoxyethyl adipate and dibutoxypropoxypropyl adipate; polymeric adipates such as polyester adipates; citrates, such as acetyltri-n-butyl citrate, phthalates such as butyl benzylphthalates, trimellitates, sebacates, polyesters, such as those known under the tradename Paraplex (available from C.P.Hall Co); phosphate esters, such as those known under the tradename of Santicizer (available from Ferro) such as 2-ethylhexyl diphenyl diphosphate and t-butylphenyl diphenyl phosphate; glutarates such as Plasthall 7050 (a dialkyl diether glutarate available from C.P.Hall Co.); and mixtures thereof.

The plasticizing agent may be used in amounts of from about 1 to 100 pbw per 100 pbw of the copolymer. Most preferably, the plasticizing agent is present in amounts up to 10 wt. % plasticizer, relative to the weight of the copolymer.

The pressure sensitive adhesive composition can be applied to any suitable substrate that can be a sheet, a fiber, or a shaped article. However, the preferred substrates are those used for pressure sensitive adhesive products.

The present invention further provides adhesive articles comprising the cured adhesive composition disposed on a backing or suitable substrate. In addition to a variety of traditional pressure sensitive adhesive articles, such as tapes, labels, decals, transfer tapes and other articles the pressure sensitive adhesive article can be used in decorative, light management and optical articles.

Suitable materials useful as the flexible support or backing for the adhesive articles of the invention include, but are not limited to, polyolefins such as polyethylene, polypropylene (including isotactic polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivates, such as cellulose acetate and cellophane, and the like. Commercially available backing materials useful in the invention include kraft paper (available from Monadnock Paper, Inc.); spun-bond poly(ethylene) and poly(propylene), such as Tyvek™ and Typar™ (available from DuPont, Inc.); and porous films obtained from poly(ethylene) and poly(propylene), such as Teslin™ (available from PPG Industries, Inc.), and Cellguard™ (available from Hoechst-Celanese).

Typical examples of flexible backing materials employed as conventional tape backing that may be useful for the adhesive compositions include those made of paper, plastic films such as polypropylene, polyethylene, polyester (e.g., polyethylene terephthalate or poly(lactic acid)), cellulose acetate, ethyl cellulose, their copolymers and their derivatives. Films comprised of polymer blends or of multiple film layers may be used. Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metallized polymer films, or ceramic sheet materials may take the form of any article conventionally known to be utilized with pressure sensitive adhesive compositions such as labels, tapes, signs, covers, marking indicia, and the like.

The above-described adhesive compositions are coated on a substrate using conventional coating techniques modified as appropriate to the particular substrate. For example, these compositions can be applied to a variety of solid substrates by methods such as roll, brush coating, flow, dip, spin, spray, knife, spread, wire, gravure, doctor blade and die coating. These various methods of coating allow the compositions to be placed on the substrate at variable thicknesses thus allowing a wider range of use of the compositions.

The coating thickness will vary depending upon various factors such as, for example, the particular application, the coating formulation, and the nature of the substrate (e.g., its absorbency, porosity, surface roughness, crepe, chemical composition, etc.). Coating thicknesses of 2-250 micrometers (dry thickness), preferably about 10 to 200 micrometers, are contemplated. The coatable adhesive composition may be of any desirable concentration for subsequent coating, but is typically between 30 to 70 wt. % solids, and more typically between 65 and 35 wt. % solids, with the remainder solvent or water. The desired concentration may be achieved by further dilution of the adhesive composition, or by partial drying.

The flexible support or backing may also comprise a release-coated substrate. Such substrates are typically employed when an adhesive transfer tape is provided. Examples of release-coated substrates are well known in the art. They include, by way of example, silicone-coated kraft paper and the like. Tapes of the invention may also incorporate a low adhesion backsize (LAB) and/or a primer. Typically the primer is applied to the same tape backing surface as the adhesive, prior to adhesive coating, while the LAB is applied to the tape backing surface that is opposite that bearing the pressure sensitive adhesive. LABs and primers are known in the art.

### EXAMPLES

These examples are merely for illustrative purposes only and are not meant to be limiting on the scope of the claims. All parts, percentages, ratios, etc. in the examples and the rest of the specification are by weight, unless noted otherwise. Solvents and other reagents used were obtained from Sigma-Aldrich Chemical Company; Milwaukee, Wisc. unless otherwise noted.

Table of Abbreviations

| Abbreviation or | |
|---|---|
| Trade Designation | Description |
| 2-OA | 2-octyl acrylate |
| IOA | Isooctyl acrylate |
| BA | Butyl acrylate |
| MAA | Methacrylic acid |
| 2-EHA | 2-ethylhexyl acrylate |
| AA | Acrylic acid |
| DS-10 | Rhodacal DS-10, sodium dodecylbenzene sulfonate, |
| | available commercially from Rhodia Corporation, |
| | Courbevoie, France |
| VAZO 64 | azobis(isobutyronitrile) free radical initiator |
| | commercially available from DuPont, Wilmington, |
| | DE |
| B-212 | Bisamide crosslinker, 1,1′-isophthaloyl- |
| | bis(2-methylaziridine) (CAS number 7652-64-4) |
| | used in solution as a 5% by weight solution of |
| | bisamide in toluene. |
| PLA | A polylactic acid film having a thickness of 41 |
| | micrometers (1.6 mils) commercially available from |
| | BIAX International, Inc., Wingham, Ontario. |

### Test Methods

### Peel Adhesion Testing

The peel adhesion test method used was similar to test method ASTM D 3330-78 except that a glass substrate was used in place of stainless steel. Two 1.3 centimeter (0.5 inch) strips of sample tapes were adhered to a glass plate by rolling a 2 kilogram (4.5 pounds) roller onto the tape. The bonded assembly dwelled at room temperature for about one minute and was tested for 180° peel adhesion using an IMASS slip/peel tester (Model 3M90, commercially available from Instrumentors Inc., Strongsville, Ohio) at a rate of 229 centimeters per minute (90 inches per minute). Peel force was measured in ounces per 0.5 inch and converted to Newtons per decimeter (N/dm). Samples were run in triplicate and averaged. The tests were run at 23° C. and 50% relative humidity unless otherwise specified.

### Shear Strength Testing

The shear strength test method used was similar to test method ASTM D-3654-78, PSTC-7. Strips of sample tapes 1.3 centimeter (0.5 inch) wide were adhered to stainless steel plates and cut down to leave 1.3 centimeter by 1.3 centimeter (0.5 inch by 0.5 inch) square on the steel plates. A weight of 2 kilograms (4.5 pounds) was rolled over the adhered portion. A weight of 1,000 grams was attached to each sample which was suspended until the sample failed. The time of failure was Samples were run in triplicate and averaged. The tests were run at 23° C. and 50% relative humidity unless otherwise specified.

### Preparative Example for 2-Octyl Acrylate

In one typical preparation, a mixture of 2-octanol (268.51 grams, 2.1 mol), AA (183.75 grams, 2.6 mol), p-toluenesulfonic acid monohydrate (5.00 grams, 26 mmol), toluene (250 grams) and phenothiazine (1.0 grams) was heated to reflux. Water was separated from the toluene/water azeotrope using a Dean Stark distillation trap. After six hours at reflux a total of 37 milliliters of water was collected in the trap. The reaction mixture was washed with 1 molar aqueous sodium hydroxide (200 milliliters), then concentrated under reduced pressure. The remaining oil was distilled under reduced pressure (65-67° C. at 2 mmHg) to give the product as a colorless oil. (Yield: 248.6 grams)

### Solution and Emulsion Polymerizations

Solution and emulsion co-polymerizations of 2-OA with other monomers were performed by combining the materials shown in Table 1 in a glass jar, purging with nitrogen for 5 minutes, and sealing the jars. The jars were placed in a Launderometer set to 70° C. for 20 hours. Viscosities of solution polymers were determined using a Brookfield viscometer with an RV-4 spindle.

TABLE 1

| Example | Composition | Viscosity (cP) |
|---|---|---|
| 1 | 14 g 2-OA, 2.8 g AA, 23.2 g BA, 60 g ethyl acetate, 0.088 g | 11200 |
| | Vazo 64 | |
| 2 | 18 g 2-OA, 1 g AA, 1 g MAA, 16 g IOA, 4 g | 1100 |
| | 2-EHA, 60 g ethyl acetate, 0.088 g Vazo 64 | |
| 3 | 22 g 2-OA, 2 g AA, 16 g 2-EHA, 60 g ethyl acetate, 0.088 g | 1100 |
| | Vazo 64 | |
| 4 | 26 g 2-OA, 2 g MAA, 12 g BA, 60 g ethyl acetate, | 1080 |
| | 0.088 g Vazo 64 | |
| 5 | 30 g 2-OA, 2 g AA, 8 g 2-EHA, 60 g ethyl acetate, 0.088 g | 920 |
| | Vazo 64 | |
| 6 | 34 g 2-OA, 0.4 g AA, 5.6 g BA, 60 g ethyl acetate, 0.088 g | 1360 |
| | Vazo 64 | |
| 7 | 67 g Water, 0.11 g Na₂HPO₄, 0.611 g DS-10, 43.43 g 2- | Not tested |
| | OA, 9.153 g BA, 1.615 g MAA, 0.016 g CBr₄, 0.081 g K₂S₂O₈ | |
| 8 | 67 g Water, 0.11 g Na₂HPO₄, 0.611 g DS-10, | Not tested |
| | 21.68 g 2-OA, 30.89 g BA, 1.615 g MAA, 0.016 g CBr₄, | |
| | 0.081 g K₂S₂O₈ | |
| C1 | 34 g IOA, 0.4 g AA, 5.6 g BA, 60 g ethyl acetate | 15800 |
| | 0.088 g Vazo 64 | |

Emulsion polymers (Examples 7 & 8) exhibited some degree of coagulation during polymerization, and no further quantitative testing was done on these samples. However, it was noted that the emulsion samples were functional as pressure sensitive adhesives after water was removed by evaporation.

### Preparation and Testing of Tape Samples

To prepare tape samples, 10.0 grams of solution Examples 1, 2, 4, 5, and 6 in Table 1 were placed into a vial along with the corresponding amount of B-212 chemical crosslinker. The amount of B-212 in the formulations was varied between 0 and 0.3 weight % as shown in Table 2. Resulting solutions were coated with a knife coater onto PLA film. The knife height was set to 102-127 micrometers (4-5 mils) above the polyester to get a coating that is about 25 micrometers (1 mil) when dried. The coated solution was allowed to air dry for 2 minutes to remove the solvent. The coated PLA sheet was then taped onto a thin rigid panel and placed into an oven at 70° C. for 5 minutes. After the sample was removed from the oven, a release liner was placed on the adhesive to protect the coating. The coated films were allowed to equilibrate in a constant temperature/constant humidity (23° C./50% Relative Humidity) room for 24 hours prior to testing. Tape testing was performed as described in the test methods above; the data are presented in Table 2.

TABLE 2

| | | Peel | | |
|---|---|---|---|---|
| | B-212 | adhesion | Shear | Peel adhesion |
| Example | crosslinker* | (oz/0.5″) | adhesion (min.) | (N/dm) |
| 1-A | 0.0 g | 48.5 | 2.7 | 106 |
| 1-B | 0.3 g | 29 | 264.7 | 63 |
| 2-A | 0.0 g | 46.8 | 1.9 | 102 |
| 2-B | 0.3 g | 27.1 | 22.3 | 59 |
| 4-B | 0.3 g | 25.2 | 18.2 | 55 |
| 5-B | 0.3 g | 26.8 | 43 | 58 |
| 6-B | 0.3 g | 22 | 6.7 | 48 |

### Preparation and Testing of Thermal Stability Samples

To prepare thermal stability testing samples, 10 g of solution polymer Examples 6 and C1 were placed into a vial along with the corresponding amount of B-212 chemical crosslinker. This solution was coated with a knife coater onto a silicone release liner. The knife height was set to 254 micrometers (10 mils) above the liner. The coated solution was allowed to air dry for 5 minutes to remove the solvent. The coated film was then taped onto a thin aluminum panel and placed into an oven at 150° C. for 2 minutes. The coated adhesives were allowed to equilibrate in constant temperature/constant humidity (CT/CH) room for 24 hours prior to testing. To determine the degradation onset temperature, a sample of the adhesive (approximately 30-65 milligrams) was analyzed using a TA Instruments TGA 2950 Thermogravimetric Analyzer (TA Instruments Inc., New Castle, Del.). The sample was subjected to a temperature ramp from room temperature to 500° C. at a rate of 10° C./min. The onset point of degradation was then determined from the sample weight versus temperature plot (calculated using the TA Instruments Universal Analysis software). Thermogravimetric testing was also used to compare the thermal stability of each adhesive at 150° C. and 175° C. In this experiment sample temperatures were increased from room temperature to the desired set point (either 150° C. or 175° C.) at 200° C./min and kept at the set point for 3.5 hrs. Sample weight was monitored and the weight loss after 3.5 hrs was determined based on the original weight of the sample. Data are presented in Table 3; data collected at 150° C. is the average of two trials with qualitatively similar results.

TABLE 3

| | | | Weight loss at | Degradation |
|---|---|---|---|---|
| | | Weight loss | (175° C., | Onset |
| | B-212 | (150° C., 3.5 hrs.) | 3.5 hrs) | Temperature |
| Example | (wt %) | (%) | (%) | (° C.) |
| 6-TGA | 0.1 | 0.45 | 1.61 | 320 |
| C1-TGA | 0.1 | 0.80 | 2.29 | 349 |

1. An adhesive composition comprising a copolymer which is the reaction product of:
1) 30 to less than 90 wt. % of 2-octyl (meth)acrylate;
2) 0.5 to 20 wt. % of a (meth)acrylic acid comonomer; and
3) other monomers.

2. The adhesive composition of claim 1, wherein the 2-octyl (meth)acrylate is the reaction product of 2-octyl alcohol with acrylic acid, wherein the 2-octyl alcohol has a ¹⁴C/C ratio of 1.0×10⁻¹⁴ or higher.

3. The adhesive composition of claim 1, wherein the other monomers include monomers selected from the group of primary octyl acrylates.

4. The adhesive composition of claim 2, wherein the other monomers include monomers selected from the group of primary octyl acrylates.

5. The adhesive composition of claim 1, further comprising a tackifier.

6. The adhesive composition of claim 1, further comprising a plasticizer.

7. The adhesive composition of claim 1, further comprising a crosslinking agent.

8. The adhesive composition of claim 7, wherein the crosslinking agent is selected from the group consisting of peroxides, multifunctional aziridine, isocyanate, oxazole and epoxy compounds.

9. The adhesive composition of claim 1, wherein the (meth)acrylic acid comonomer is selected from the group consisting of acrylic acid, methacrylic acid, and combinations thereof.

10. The adhesive composition of claim 1 wherein said copolymer comprises 60 to less than 90 wt. % of 2-octyl(meth)acrylate, 0.5 to 10 wt. % of (meth)acrylic acid, and 10 to 39.5 wt. % butyl(meth)acrylate.

11. The adhesive composition of claim 1 wherein said copolymer consists essentially of 60 to less than 90 wt. % of 2-octyl(meth)acrylate, 0.5 to 10 wt. % of (meth)acrylic acid, and 10 to 39.5 wt. % butyl(meth)acrylate.

12. An adhesive article comprising the adhesive composition of claim 1 and a backing.

13. The adhesive article of claim 12, wherein said backing is selected from polyolefins, polystyrene, polyester, polyvinyl chloride, polyvinyl alcohol, polyurethane, poly(vinylidene fluoride), cellulose and cellulose derivates.

14. An adhesive comprising the adhesive composition of claim 1 wherein said adhesive composition is cross linked.

15. A copolymer comprising the reaction product of:
1) 2-octyl(meth)acrylate;
2) 0.5 to 20 wt. % of a (meth)acrylic acid comonomer; and
3) at least 10 wt. % other monomers.
